(19) United States
(12) Patent Application Publication
(10) Pub. No.: US 2007/0041705 A1
(43) Pub. Date: Feb. 22, 2007

(54) Selective recording for digital video recorders using implicit correlation

(76) Inventor: Raymond C. Bontempi, Jamison, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/207,979

(22) Filed: Aug. 19, 2005

(51) Int. Cl. H04N 5/91

(52) U.S. Cl. 386/83

(57) ABSTRACT

A method and apparatus for identifying programming that is estimated to meet a preference of a user is provided. An implicitly correlated list is generated using a correlation engine by estimating similarity of user recording logs corresponding to a plurality of users where each user recording log comprises implicit data associated with programming recorded by respective users in the plurality. In a preference engine, an identification of a program is taken from the implicitly-correlated list and matched against content to be broadcast in the future to create a matching list. DVR programming parameters are stored in a memory using the matching list.

### FIELD OF THE INVENTION

This invention is related generally to video recording, and more particularly to selective recording for digital video recorders using implicit correlation.

### BACKGROUND OF THE INVENTION

Digital video recorders (DVRs) have become increasingly popular for the flexibility and capabilities offered to users in selecting and then recording video content such as that provided by cable and satellite television service companies. DVRs, are consumer electronics devices that record television shows to a hard disk in digital format. Since being introduced in the late 1990s, DVRs have steadily developed complementary abilities, such as recording onto DVDs.

DVRs allow the “time shifting” feature (traditionally done by a video cassette recorder or VCR) to be performed more conveniently, and also allow for special recording capabilities such as pausing live TV, instant replay of interesting scenes, and skipping advertising.

DVRs were first marketed as standalone consumer electronic devices. Currently, many satellite and cable service providers are incorporating DVR functionality directly into their set-top-boxes (STBs). Service providers can thus readily implement features such as automatic hard disk space management whereby old recordings are deleted to make room for new ones; the maximum number of episodes to keep on weekly recordings may be specified; and, the maximum number of days or weeks to keep individual recordings may be set.

Users may program DVRs to record television programs run on specific channels and at specific times just as they would conventional analog video recorders such as VCRs. But in addition, DVRs may generally be programmed by the user to record preferred or desired programs by interacting with a programming interface that gives more choices to the user called an electronic program guide (EPG) or interactive program guide (IPG). Like printed television program guides, EPGs contain grids listing the available television programs.

Among other uses, EPGs make it easier for a user to select programming to be recorded on the DVR. For example, a user may want to record all episodes in a TV series. By interacting with, or downloading program information from an external database that provides EPG data (which is typically maintained by the service company), the DVR will then record the chosen programs without further interaction from the user. That is, the user need only to choose the program, for example by selecting the program title using the EPG. and the DVR will record the appropriate channel at the correct time by scanning EPG data as it becomes available.

A number of schemes are used to provide users with an opportunity to select video programming to be recorded on a DVR without requiring the user to review EPGs or other programming guides. For example, on some available DVR systems, users may rate shows to thereby indicate programs that the user likes or dislikes. Other systems may allow the user to create a user profile that includes preferred genres (e.g., action, science-fiction, westerns, romance etc.) actors, directors or age of the program (e.g., classic, contemporary) or other attributes. In both cases, such DVR systems look to match the preferences of the user with received program data, such as an EPG, to make recommendations or suggestions for programs to be recorded that the system predicts or estimates would be liked by the user.

In the examples noted above, users are given choices for recommended programs that can be recorded by the DVR in the future once the programs are broadcast. While providing users with more choices, such methods utilize attributes or properties (collectively “data”) that are explicitly associated with the programs such as user ratings or content-dependent data such as actors, director, genre, and production date. For such explicit data to be used by the system, users are required take affirmative steps to rate programs or create a preference profile which indicates, for example, favorite genres, actors, directors, etc.

Systems using specific user input including explicitly generated program ratings and user profiles are not ideal in all circumstances. For example, it has been noted that many users may be reluctant or unwilling to provide explicit ratings of shows that are recorded (for example, due to the time it takes to make the rating), or that the ratings provided do not accurately reflect the user's actual preferences. New and less mainstream shows (or programs like sporting events that are not generally shown in reruns) can suffer from the “cold start syndrome” where a lack of sufficient explicit rating data makes reliable and accurate predictions difficult. User's preferences can also change over time and both ratings and user profiles may become less valuable as prediction tools as they age over time. In addition, reliance on explicit data may tend to provide recommendations for programming that tends to be similar (for example, as they fit preferred genres in the user profile and may be highly rated within that genre). Consequently, a user may be provided with a long list of home improvements show, but a dissimilar science documentary or sports show—that would still be liked by a user but is outside the explicit user profile or not been viewed enough to be accurately rated—may be missed.

What is needed, then, is an approach to generating recommended programs for DVR recording that does not require explicit or content-dependent data to be collected from the user.

### BRIEF DESCRIPTION OF THE DRAWINGS

FIG. 1 is a diagram of an illustrative arrangement showing similarity estimation for implicitly-correlated data;

FIG. 2 shows a database record format which may be used to implement user recording logs;

FIG. 3 shows a database record format which may be used to implement user recording logs; and

FIG. 4 is a diagram of another illustrative arrangement showing a client-server architecture where the client receives an implicitly correlated list of programs for recording.

### DETAILED DESCRIPTION

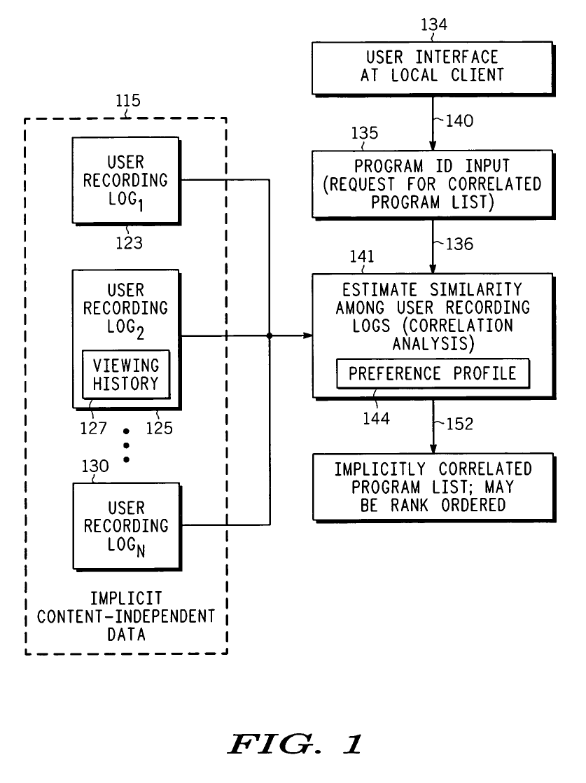

FIG. 1 is a diagram of an illustrative arrangement showing similarity estimation for implicitly-correlated data. A number of user recording logs, 1, 2 . . . N (collectively designated by reference numeral 115 in FIG. 1) are shown. User recording logs 115 are utilized to track the programs that are recorded by respective users on their DVRs over some arbitrary time period. Typically, user recording logs 115 are maintained locally in a database disposed in a persistent or volatile memory in individual DVRs, or in STBs that incorporate DVR functionality. Typically, such DVRs and STBs are arranged as local clients on a network such as a cable television network. Video recording logs 115 may be uploaded to a remote server (e.g., at the network's head end—not shown in FIG. 1) continuously or periodically as required by a specific DVR recording application.

User recording logs 115 are preferentially arranged to track implicit data associated with the programs (and thus, if user recording log 115 are considered as a set, then the programs included in the log are considered to be members of the set). Implicit data, as used here, means that data which is inherently associated with a program. Implicit data at a minimum comprises data to uniquely identify the program such as title or unique program ID. In some applications, implicit data may also include information relating to running length (i.e., how long the program runs in time), service delivery data/attributes including time of day of broadcast, broadcast channel, or another inherent attribute that is not related to the content of the program, nor related to the popularity (i.e., user rating) of the program.

Implicit data is typically collected indirectly by a user's action when using a DVR. Thus, no affirmative steps need be taken by a user in order for the implicit data to be logged. For example (and as described in more detail below), implicit data may include the percentage of a program which is viewed by a user. Such implicit data is thereby created when the user stops the DVR and doesn't view the remainder of the recorded program.

Implicit data is defined to exclude explicit person-generated attributes of the program (such as feedback, rankings, ratings by users, critics or other sources, etc.) and also content-dependent attributes (such as genre, actors, director, date of production, etc.) which are neither utilized nor tracked in the illustrative arrangements described herein.

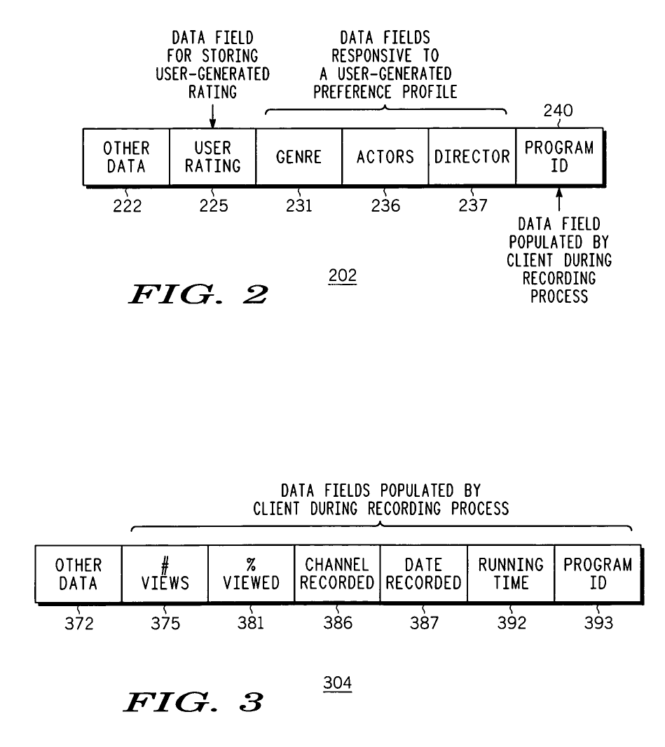

The definition of implicit data as used herein (and as compared with explicit attributes and content-dependent attributes) is further illustrated in FIGS. 2 and 3 which show database record formats which may be used to implement the user recording logs 115 (FIG. 1) in some applications. Each user recording log will typically contain one database record for each program logged in the user recording log.

Database record 202 in FIG. 2 is an example of a database record for explicit data. Database record 202 shows that a unique program identifier (program ID) field 240 is used in conjunction with fields to store explicit data. Fields 231, 236 and 237 store content-dependent data including genre, actors, and director data, respectively, in this example. These fields store data that are responsive to a user-generated preference profile. Field 225 is used to store a user-generated rating for the program. Field 222 may be used to store other data which may be used for purposes which are not related to selective recording using implicit correlation.

Database record 304 in FIG. 3 is an example of a database record for implicit data as used in this illustrative arrangement. Database record 304 shows the unique program ID in field 393. Fields 372, 375, 381, 386, 387 and 391 are used to store other implicit data including viewing history data (number of times viewed and/or percentage of programmed viewed), the television channel recorded, the date recorded and the length of the program (i.e., running time), respectively. Field 372 may be used to store other data which may be used for purposes which are not related to selective recording using implicit correlation.

In some applications of selective recording using implicit correlation, only a program ID such as a program title or other unique identification (such as that provided by the Tribune Media Services) needs to be tracked in the user recording log. In such an example, as a user selects programs for recording on a DVR, the program ID is appended to the database log in a user recording log (e.g., user recording log 123 in FIG. 1).

Returning back to FIG. 1, viewing history 127 is illustratively shown in FIG. 1 as part of viewer recording log 125 to show an alternative or optional arrangement whereby other implicit and content-independent data may be tracked. Viewing history 127 may include data which is indicative of how a recorded program is actually viewed by a user, recognizing of course, that a user may record a program, but only watch a portion of it, or watch it more than once, or indeed delete it without watching it at all. Such viewing history may be useful in determining a user's program preferences, but the viewing history notably does not require that the user generate explicit data in order for it to be created and tracked.

As shown in FIG. 1, the user recording logs 115 are provided into estimate similarity block 141. Here, a correlation analysis among the user recording logs 115 is performed using an algorithm that is designed to make a mathematical estimate of the degree to which the video recording logs 115 are similar using only the implicit data contained in the logs.

While a variety of algorithms may be utilized, one particularly useful algorithm as used in this illustrative arrangement performs correlation through the correspondence of identical entries among the user recording logs. In this example, a pair of user recording logs have high correlation when a high number of programs ID are concurrently contained in each of the user recording log pair. And, a pair of user recording logs has low correlation when a low number of program IDs are concurrently contained in each of the user recording log pair. Thus, referring again to FIG. 1, if user recording log 123 and user recording 125, for example, have five programs common to both, then they would be more highly correlated under this algorithm than would user recording log 123 and user recording log 130 if they only commonly shared two programs.

A request for implicitly correlated program list is provided on line 136. In this example, the request is generated from a local client 134 using a user interface. Such an interface is typically interactive using a display and an input device so that a user may see selections and make choices. For example, many user interfaces are implemented using a EPG or similar guide that is displayed by the DVR or STB on a coupled television set. The user navigates menus using a remote control in most applications.

In the arrangement shown in FIG. 1, if a program is selected for recording (the “selected program”), then the user may be presented with an option to record other programs that are estimated to be liked by that user. A program ID associated with the selected program forms the basis for the request on line 136. The selected program is correlated against those recording logs of users which have the selected program as member (i.e., which means that such users recorded the selected program at some prior point in time).

On line 152, the output of estimate similarity block 141 is a list of programs that are correlated to the input request on line 136. The list comprises programs that are contained in the most highly correlated user recording logs in which the selected program is a member. The list may be ranked ordered according to the correlation strength. The estimation of similarity among user recording logs is thus used to create a preference profile for the user. The rationale here is that a consensus of other users as to which programs are liked given that their recording logs have a significant overlap (i.e., correlation) among the programs that were chosen to be recorded on their DVRs. As these users also recorded the selected program, implicit correlation among their recording logs can accurately estimate the preferences of the user who picked the selected recording.

In some applications, a user's own recording log may be utilized in instances where higher correlation is required to increase the probability that list entries on line 152 will be liked by a user. In this case, a user recording log of a particular user (for example user recording log 130 in FIG. 1) is used as a baseline and a similarity distance from the baseline is calculated for each of the other user recording logs 115 from 1, 2 . . . N. The output list from estimate similarity block 141 comprises programs that are contained in user recording logs that are most highly correlated to the particular user's recording log 130, and in which the selected program is a member. Given the assumption that a particular user's own recording log contains programs that are well liked, then other user recording logs that are highly correlated with that log can be expected to contain other programs that will also be liked by that particular user. Again therefore, the implicit correlation described above is used to create a preference profile for the user to enable the estimation of programs that will be liked by the user.

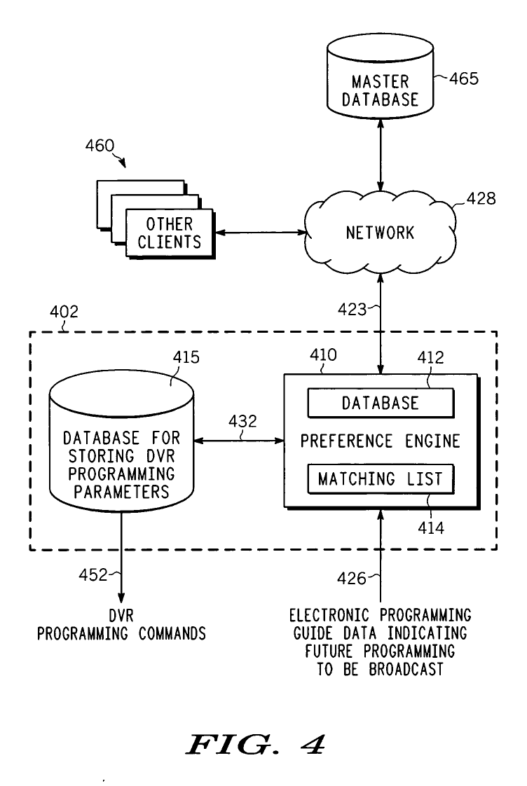

Turning now to FIG. 4, a diagram of another illustrative arrangement is shown which includes a client-server architecture where the client receives an implicitly correlated list of programs for recording. A plurality of clients 460 is coupled through a network 428 to a master database 465 (i.e., server). Network 428 may take the form of the Internet or other network such as a cable television network. Clients 460 typically comprise DVRs or STBs, or STBs that incorporate DVR functionality.

One client 402 is shown in detail in FIG. 4. Preference engine 410 is coupled to the network 428 through a network interface 423 to send requests for an implicitly correlated program list to the master database 465 and receive such lists. Preference engine 410 is further coupled to receive EPG data from an external source that is indicative of programming that will be broadcast and available for recording in the future. In some applications, the EPG could be stored and served from master database 465.

Within preference engine 410 is a database 412 or other memory that is configured to store an implicitly correlated program list that is downloaded from the master database 465 to clients 460. Preference engine 410 periodically receives EPG data updates over line 426 to thereby receive a schedule of upcoming programming. Preference engine 410 scans such incoming EPG data for matches to the implicitly correlated program list which is stored in database 412. When matches are identified, the matches are stored in matching list 414 which is disposed in preference engine 410 as indicated.

Preference engine 410 is coupled to database 415 which stores DVR programming parameters so that matches contained in the matching list 414 may be used to schedule the DVR to record the matched upcoming program at the appropriate time and channel. Such programming parameters are stored in database 415 until needed. At such time, the DVR operating commands are sent over line 452 to a DVR (not shown in FIG. 3) to trigger the recording.

An example of implicit correlation follows. Two users—user A and user B—each record a number of programs that they plan to watch. User A's user recording log (e.g., 123 in FIG. 1) contains 10 programs. Each user recording log in this example includes only a program ID to uniquely identify each program among all the programs that are available for recording. For simplicity of illustration, two-digit program IDs are used and are arbitrarily assigned. Although the user recording log does not track the genres (as genre is not an implicit data type), the programs contained therein in this example are distributed among the following genres: western, science fiction, home improvement, and sports.

Similarly, user B's user recording log (e.g., 125 in FIG. 1) contains 12 programs distributed among the genres of sports, history and news.

Tables 1 and 2 below identify the program ID data contained in the user recording logs of user A and user B, respectively. Note that only program IDs are tracked as implicit data in the user recording logs. The genres are identified in the tables are only for descriptive purposes in this example.

TABLE 1

| | | Genre |
|---|---|---|
| Number | Program ID | (not tracked in user recording log) |
| 1 | 12 | Western |
| 2 | 23 | Home improvement |
| 3 | 26 | Science Fiction |
| 4 | 06 | Western |
| 5 | 10 | Sports |
| 6 | 31 | Sports |
| 7 | 17 | Science Fiction |
| 8 | 98 | Home improvement |
| 9 | 32 | Sports |
| 10 | 70 | Home improvement |

TABLE 2

| | | Genre |
|---|---|---|
| Number | Program ID | (not tracked in user recording log) |
| 1 | 10 | Sports |
| 2 | 77 | News |
| 3 | 31 | Sports |
| 4 | 11 | Sports |
| 5 | 78 | Sports |
| 6 | 01 | History |
| 7 | 19 | News |
| 8 | 96 | History |
| 9 | 32 | Sports |
| 10 | 63 | News |
| 11 | 41 | Sports |
| 12 | 04 | History |

User recording logs from user A and user B may be received and stored on a master database (e.g. 465 in FIG. 4). The user recording logs are implicitly correlated as described in the text accompanying FIG. 1 above with other user recording logs which are stored on the master database 465.

Table 3 below is an illustrative user recording log of user C (and that is stored on the master database 465) which is relatively well correlated with the user recording log of user A as shown in Table 1. In this example, the user recording log of user C contains eight members that are the same as user A (program IDs 12, 23, 26, 06, 10, 98, 32 and 70) and four members that are different.

TABLE 3

| | | Genre |
|---|---|---|
| Number | Program ID | (not tracked in user recording log) |
| 1 | 12 | Western |
| 2 | 23 | Home improvement |
| 3 | 26 | Science Fiction |
| 4 | 06 | Western |
| 5 | 10 | Sports |
| 6 | 31 | Sports |
| 7 | 01 | Comedy |
| 8 | 04 | History |
| 9 | 98 | Home improvement |
| 10 | 13 | Game show |
| 11 | 32 | Sports |
| 12 | 70 | Home improvement |

Continuing this example, after consulting with an EPG, user A decides to record a program being broadcast later in the day using user interface 134 (FIG. 1). While user A interacts with the EPG and may select the program by title, the selected program is logged in the user recording log by its unique program ID (in this example, a program ID of 10). This program ID forms program ID input 135 (i.e., a request for an implicitly correlated program list).

The selected program having program ID 10 is compared against user recording logs 115 to identify those which contain it as a member. The more highly correlated user recording logs form the basis for populating the implicitly correlated program list (which is output on line 152 from estimate similarity block 141 in FIG. 1). As noted above, the user recording log from user C shown in Table 3 contains the selected program with program ID 10 and is also well correlated to the user recording log from user A.

In this example, the implicitly correlated program list would contain the four disparate programs from Table 3. These four programs (having program IDs of 31, 01, 04, 13) would form the basis for creating a preference profile to thus identify programs that are estimated to be liked by user A. The rationale here is that user A and user C have similar preferences since their respective user recording logs have a significant overlap among the programs that were chosen to be recorded on their DVRs. Therefore, the remaining programs on user C's recording log (that are not on user A's recording log) would likely be enjoyed by user A as well. Notably, this selective recording scheme enables the preferences of an entire community users to be considered without having to track, manipulate or store any data other than implicit data.

The four programs—two sports programs, a history and a game show program—could be presented for consideration user A in a variety of ways. For example, user A may be given an option through user interface 134 (FIG. 1) to have the client 402 (FIG. 4) automatically record the programs from the implicitly correlated program list 152. Alternatively, user A may be given an option to see the entries on the program list first and then decide which, if any, of the programs on the list should be recorded.

In this example, Table 3 represents a single user recording log. However, it is contemplated that a plurality of user recording logs are correlated against the user recording log represented by Table 1. In such cases, programs from more than one user recording log may used as entries on the program list 152. A rank order scheme may then be used where the program list is presented to user A with programs from logs which are more highly correlated with Table 1 being displayed on user interface 134 as more highly recommended than programs from logs which are less well correlated with Table 1. In addition, other implicit data including number of views, percents views (see e.g., FIG. 3) may be used to create the rank ordered list.

Table 4 below is an illustrative user recording log of user D (and that is stored on the master database 465) which is relatively well correlated with the user recording log of user B as shown in Table 2. In this example, the user recording log of user D contains nine members that are the same as user A (program IDs 10, 31, 04, 01, 19, 96, 32, 63 and 41) and three members that are different.

TABLE 4

| | | Genre |
|---|---|---|
| Number | Program ID | (not tracked in user recording log) |
| 1 | 10 | Sports |
| 2 | 13 | Game show |
| 3 | 31 | Sports |
| 4 | 04 | History |
| 5 | 70 | Home improvement |
| 6 | 01 | History |
| 7 | 19 | News |
| 8 | 96 | History |
| 9 | 32 | Sports |
| 10 | 63 | News |
| 11 | 41 | Sports |
| 12 | 02 | Comedy |

Continuing this example, after consulting with an EPG, user E decides to record a program being broadcast later in the day using user interface 134 (FIG. 1). Unlike the scenario with user A as described above the selected program from user E (in this example a program ID of 31) is not logged in a user recording log. Avoiding use of a particular user's recording log may be beneficial in some applications as it is recognized that selective DVR recording using implicit correlation may still be implemented.

The selected program having program ID 31 is compared against user recording logs 115 to identify those which contain it as a member. The more highly correlated user recording logs form the basis for populating the implicitly correlated program list (which is output on line 152 from estimate similarity block 141 in FIG. 1). As noted above, the user recording log from user B and user D shown in Tables 2 and 4, respectively both contain the selected program with program ID 31 and are both well correlated to each other.

In this example with user E, the implicitly correlated program list would contain the programs from Tables 2 and 4 that are not commonly shared between Tables 2 and 4. These six programs (having program IDs of 77, 11, 78, 13, 70 and 02) would form the basis for generating a preference profile to identify programs that are estimated to be liked by user E. Although as noted above, a preference profile for user E is not be used, the rationale here is that a consensus of other users (in this case users B and D) as to liked programs as their recording logs have a significant overlap among the programs that were chosen to be recorded on their DVRs. Therefore, as both user B and D also recorded program ID 31 (as did user E) then the remaining disparate programs on user B's recording log and user D's recording log (i.e., the programs that were not common to both logs) would likely be enjoyed by user E as well. In this example with user E, only the two user recording logs from Tables 2 and 4 are used for the sake of clarity in presentation. However, a plurality of user recording logs may be used to establish the consensus among users. As with the example with user A, this selective recording scheme enables the preferences of an entire community users to be considered without having to track, manipulate or store any data other than implicit data

As described in detail above, the selective DVR recording with implicit correlation arrangement advantageously provides a wide variety of recommended programming that is estimated to be liked by a user without requiring affirmative and time-consuming entry of explicit data by the user. Other features of the invention are contained in the claims that follow.

1. A method of identifying programming estimated to meet a preference of a user, the method comprising:
receiving a user recording log comprising implicit data associated with programs recorded by the user over a time period;
estimating similarity of the program recording log with user recording logs corresponding to a plurality of other users to create a preference profile for the user; and
identifying a program, using the preference profile, for recording from content to be broadcast in the future.

2. The method of claim 1 further including storing DVR programming parameters to schedule the program for recording.

3. The method of claim 1 where the estimating uses an algorithm for correlating the user recording logs.

4. The method of claim 1 where the implicit data is content-independent.

5. The method of claim 1 where the implicit data includes a viewing history.

6. The method of claim 5 where the viewing history indicates a duration of time in which the programs are viewed by the user.

7. The method of claim 5 where the viewing history indicates a frequency in which the programs are viewed by the user.

8. A method of operating a DVR to record programming estimated to meet a preference of a user, the method comprising:
receiving an identification of a program from an implicitly-correlated list, the implicitly correlated list being generated by estimating similarity of user recording logs corresponding to a plurality of users, each user recording log comprising implicit data associated with programming recorded by respective users in the plurality of users;
matching the identification against content to be broadcast in the future to create a matching list; and
storing DVR programming parameters using the matching list.

9. The method of claim 8 where the matching uses electronic programming guide data.

10. An apparatus for recording video programming, comprising:
a receiving subsystem for receiving an identification of a program from an implicitly-correlated list;
a preference engine for matching the identification against content to be broadcast in the future to create a matching list; and
a memory for storing DVR programming parameters that are generated using the matching list.

11. The apparatus of claim 10 where the implicitly correlated list is generated by estimating similarity of user recording logs corresponding to a plurality of users, each user recording log comprising implicit data associated with programming recorded by respective users in the plurality of users.

12. The apparatus of claim 10 further including an interactive user interface for displaying DVR recording options to the user.

13. The apparatus of claim 10 further including a user control for interacting with the user interface to thereby input user commands.

14. The apparatus of claim 10 where the preference engine is arranged to scan electronic programming guide data to create the matching list.

15. The apparatus of claim 10 where the receiving subsystem is in periodic communication with a remote server and downloads the identification into a database.

16. The apparatus of claim 10 where the matching list includes ranking information indicative of a degree of correlation between the programming and the preferences of the user.

17. At least one computer-readable medium encoded with instructions which, when executed by a processor, perform a method comprising:
receiving a user recording log comprising implicit data associated with programs recorded by the user over a time period;
estimating similarity of the user recording log with user recording logs corresponding to a plurality of other users to create a preference profile for the user; and
identifying a program, using the preference profile, for recording from content to be broadcast in the future.

18. The at least one computer medium of claim 17 where the implicit data is content-independent.

19. The at least one computer medium of claim 17 where the implicit data includes a viewing history.

20. The at least one computer medium of claim 19 where the implicit data includes a viewing history includes an indication of a viewing percentage of a program.
